(19) United States
(12) Patent Application Publication
(10) Pub. No.: US 2025/0091202 A1
(43) Pub. Date: Mar. 20, 2025

(54) DATA COLLECTION SYSTEM, AUTOMATED WORK SYSTEM, DATA COLLECTION PROGRAM, AND AUTOMATED WORK PROGRAM GENERATION PROGRAM

(71) Applicant: DENSO CORPORATION, Kariya-city (JP)

(72) Inventors: Hideki OKUDA, Kariya-city (JP); Hiroshi YAMAKITA, Kariya-city (JP); Masaomi DOBASHI, Kariya-city (JP)

(21) Appl. No.: 18/884,177

(22) Filed: Sep. 13, 2024

(30) Foreign Application Priority Data
Sep. 14, 2023 (JP) 2023-149285

(51) Int. Cl. B25J 9/16

(52) U.S. Cl. CPC B25J 9/163

(57) ABSTRACT

A data collection system collects data required to generate an automated work program that causes a control target to automatically perform predetermined work. The data collection system instructs presentation of a work guide that indicates a work process for work elements. The data collection system acquires an operation log of a log collection system during execution of the work element. The data collection system acquires an image log of the log collection system during execution of the work element. The data collection system acquires time data indicating time required to execute the work element. The data collection system acquires evaluation data indicating evaluation of an execution result of the work element. The data collection system causes a data storage unit to store therein a work element log in work element units in association with the operation log, the image log, the time data, and the evaluation data.

### CROSS-REFERENCE TO RELATED APPLICATIONS

This application is based on and claims the benefit of priority from Japanese Patent Application No. 2023-149285, filed on Sep. 14, 2023. The entire disclosure of the above application is incorporated herein by reference.

### BACKGROUND

The present disclosure relates to a data collection system, an automated work system, a data collection program, and an automated work program generation program. An automated work system that controls operation of a control target such as a robot by an automated work program generated in advance, and causes the robot to perform predetermined work has been provided.

### SUMMARY

A first aspect of the present disclosure provides a data collection system that collects data required to generate an automated work program that causes a control target to automatically perform predetermined work. A second aspect of the present disclosure provides an automated work system that generates data required to generate an automated work program that causes a control target to automatically perform predetermined work is collected and the automated work program. A third aspect of the present disclosure provides a data collection program that is implemented by a processor included in a control unit of a data collection system that collects data required to generate an automated work program that causes a control target to automatically perform predetermined work. A fourth aspect of the present disclosure provides an automated work program generation program that is implemented by a processor included in a control unit of an automated work system that includes a data collection system that collects data required to generate an automated work program that causes a control target to automatically perform predetermined work and a control target that automatically performs the predetermined work.

### BRIEF DESCRIPTION OF THE DRAWINGS

In the accompanying drawings:

FIG. 1 is a functional block diagram illustrating an overall configuration according to a first embodiment;

FIG. 2 is a functional block diagram illustrating a control unit;

FIG. 3 is a diagram illustrating work elements;

FIG. 4 is a diagram illustrating a permutation of optimal work element logs;

FIG. 5 is a diagram illustrating a mode of connection of an automated work system;

FIG. 6 is a diagram illustrating another mode of connection of the automated work system;

FIG. 7 is a flowchart illustrating a data collection process;

FIG. 8 is a flowchart illustrating an automated work program generation process;

FIG. 9 is a flowchart illustrating an automated work program execution process; and

FIG. 10 is a functional block diagram illustrating an overall configuration according to a second embodiment.

### DESCRIPTION OF THE EMBODIMENTS

JP 2018-206286 A discloses a technology in which a simulated model of an operation by a worker is constructed through machine learning of learning data required to generate an automated work program in work element units. In the technology disclosed in JP 2018-206286 A, machine learning of an enormous amount of learning data in work element units is required to construct the simulated model. Therefore, a problem occurs in that the data required to generate the automated work program cannot be efficiently collected.

It is thus desired to provide a data collection system that is capable of efficiently and appropriately collecting data required to generate an automated work program, an automated work system, a data collection program, and an automated work program generation program.

A first exemplary embodiment of the present disclosure provides a data collection system that collects data required to generate an automated work program that causes a control target to automatically perform predetermined work. The data collection system includes: a work guide presentation instruction unit that instructs presentation of a work guide that indicates a work process for work elements; an operation log acquisition unit that acquires an operation log of a log collection system during execution of the work element; an image log acquisition unit that acquires an image log of the log collection system during execution of the work element; a time data acquisition unit that acquires time data indicating time required to execute the work element; an evaluation data acquisition unit that acquires evaluation data indicating evaluation of an execution result of the work element; and a data storage control unit that causes a data storage unit to store therein a work element log in work element units in association with the operation log, the image log, the time data, and the evaluation data.

A second exemplary embodiment of the present disclosure provides an automated work system that generates data required to generate an automated work program that causes a control target to automatically perform predetermined work is collected and the automated work program. The automated work system includes: a work guide presentation instruction unit that instructs presentation of a work guide that indicates a work process for work elements; an operation log acquisition unit that acquires an operation log of a log collection system during execution of the work element; an image log acquisition unit that acquires an image log of the log collection system during execution of the work element; a time data acquisition unit that acquires time data indicating time required to execute the work element; an evaluation data acquisition unit that acquires evaluation data indicating evaluation of an execution result of the work element; a data storage control unit that causes a data storage unit to store therein a work element log in work element units in association with the operation log, the image log, the time data, and the evaluation data; and an automated work program generation unit that generates the automated work program based on the work element logs in work element units stored in the data storage unit.

A third exemplary embodiment of the present disclosure provides a non-transitory computer-readable storage medium storing therein a data collection program that is read and executed by a processor included in a control unit of a data collection system that collects data required to generate an automated work program that causes a control target to automatically perform predetermined work. When read and executed by the processor, the data collection program causes the processor to implement: a work guide presentation instruction step of instructing presentation of a work guide that indicates a work process for work elements; an operation log acquisition step of acquiring an operation log of a log collection system during execution of the work element; an image log acquisition step of acquiring an image log of the log collection system during execution of the work element; a time data acquisition step of acquiring time data indicating time required to execute the work element; an evaluation data acquisition step of acquiring evaluation data indicating evaluation of an execution result of the work element; and an evaluation data acquisition step of causing a data storage unit to store therein a work element log in work element units in association with the operation log, the image log, the time data, and the evaluation data.

A fourth exemplary embodiment of the present disclosure provides a non-transitory computer-readable storage medium storing therein an automated work program generation program that is read and executed by a processor included in a control unit of an automated work system that includes a data collection system that collects data required to generate an automated work program that causes a control target to automatically perform predetermined work and a control target that automatically performs the predetermined work. When read and executed by the processor, the automated work program generation program causes the processor to implement: a work guide presentation instruction step of instructing presentation of a work guide that indicates a work process for work elements; an operation log acquisition step of acquiring an operation log of a log collection system during execution of the work element; an image log acquisition step of acquiring an image log of the log collection system during execution of the work element; a time data acquisition step of acquiring time data indicating time required to execute the work element; an evaluation data acquisition step of acquiring evaluation data indicating evaluation of an execution result of the work element; a data storage control step of causing a data storage unit to store therein a work element log in work element units in association with the operation log, the image log, the time data, and the evaluation data; and an automated work program generation step of generating the automated work program based on the work element logs in work element units stored in the data storage unit.

As a result of the instruction for presentation of the work guide being issued, a worker can divide the work operation in work element units based on the work guide and collect data. With reference to the time data or the evaluation data, the work element logs having excellent time data or evaluation data can be selected as optimal work element logs in work element units. As a result of the optimal work element logs selected in work element units being combined, the automated work program can be generated. As a result, machine learning of an enormous amount of learning data in work element units is not required. The data required to generate the automated work program can be appropriately and efficiently collected.

A plurality of embodiments in which the present disclosure is applied to a data collection system that collects data required to generate an automated work program that causes a robot to automatically perform work of disassembling a disused automobile will hereinafter be described. Description of sections identical to those according to preceding embodiments may be omitted in subsequent embodiments. Here, the present disclosure can also be applied to other systems as long as the system is one which collects data required to generate an automated work program that causes a control target to automatically perform predetermined work, in addition to the automated work program that causes a robot to automatically perform the work of disassembling a disused automobile.

### First Embodiment

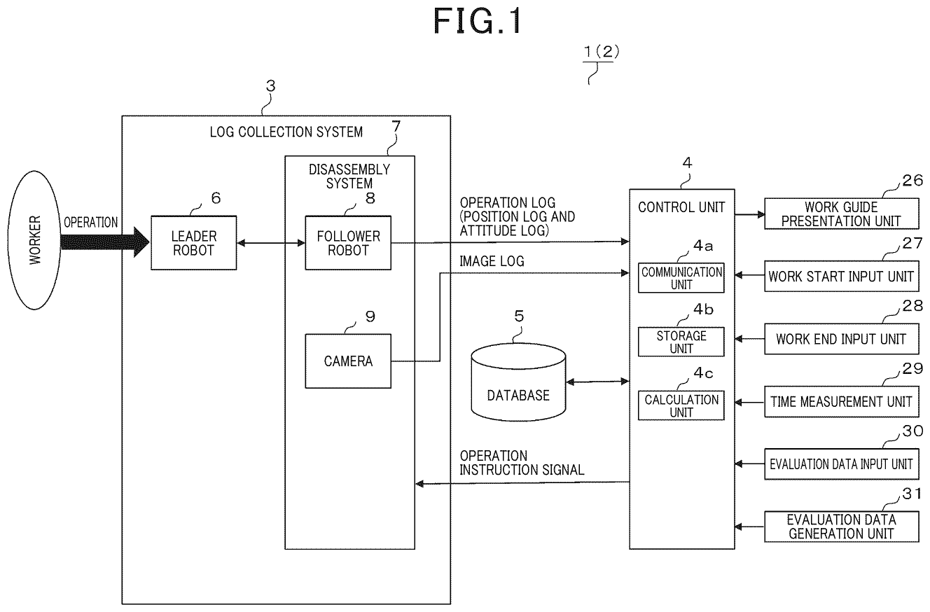

A first embodiment will be described with reference to FIG. 1 to FIG. 9. According to the first embodiment, an example will be given of a case in which the data required to generate an automated work program is collected using a robot that performs the work of disassembling a disused automobile that is an actual real machine. In this case, a data collection system and an automated work system have an identical relationship. The data collection system and the automated work system have an identical relationship if the configuration is such that the data required to generate an automated work program is collected using a control target that performs predetermined work using a real machine, that is, the data collection system includes the control target. The relationship between the data collection system and the automated work system is one in which the automated work system includes the data collection system if the configuration is such that the data required to generate an automated work program is collected using a control target that performs predetermined work using a model, a simulator, or the like described hereafter, the data collection system does not include the control target.

As shown in FIG. 1, an automated work system 1 has an identical relationship with a data collection system 2. The automated work system 1 includes a log collection system 3 that collects logs accompanying the disassembly of a disused automobile (corresponding to a work target), a control unit 4 that controls the overall system, and a database 5 (corresponding to a data storage unit). The control unit 4 and the database 5 may be integrated or separate. The database 5 may also be managed on the cloud.

The log collection system 3 includes a leader robot 6 and a disassembly system 7 that performs the work of disassembling a disused automobile. That is, the disassembly system 7 is controlled as part of the log collection system 3. The disassembly system 7 includes a follower robot 8 (corresponding to a control target) and a camera 9 that captures images of the follower robot 8. The leader robot 6 and the follower robot 8 are connected so as to be capable of data communication by a wired circuit or a wireless circuit.

The leader robot 6 is operated by a worker who carries out the work of disassembling the disused automobile. The leader robot 6 operates so as to follow an operation by the worker and outputs an operation instruction signal indicating the operation to the follower robot 8. The follower robot 8 performs the work of disassembling the disused automobile. When the operation instruction signal is input from the leader robot 6, the follower robot 8 analyzes the inputted operation instruction signal and operates based on the analysis result. That is, the follower robot 8 operates so as to follow the leader robot 6. In addition, when the operation instruction signal is input from the control unit 4 through execution of an automated work program, the follower robot 8 operates based on the inputted operation instruction signal and automatically performs the work of disassembling the disused automobile without requiring operation by the worker.

The disassembly system 7 may include, for example, a turntable that is capable of rotating in a horizontal direction in a state in which the disused automobile is placed thereon. For example, the follower robot 8 may be a six-axis articulated robot having six axes in an X-axis direction, a Y-axis direction, and a Z-axis direction, and around the X axis, the Y axis, and the Z axis. The follower robot 8 actualizes operations in the axial directions and operations around the axes in a three-dimensional space. For example, in the follower robot 8, an attachment having a pair of movable teeth may be attached to a tip end portion of an arm so as to freely swing and turn. The follower robot 8 dismantles the disused automobile by gripping, pulling, breaking, and bending a portion of the disused automobile three-dimensionally from an arbitrary direction using the pair of movable teeth of the attachment. The follower robot 8 outputs time-series data indicating the operation of disassembling the disused automobile as an operation log. The operation log includes a position log indicating a position of the follower robot 8 and an attitude log indicating an attitude. Here, the above-described configuration of the follower robot 8 is an example. Any configuration, including shape, a number of units, size, and the like, is possible as long as the follower robot 8 is able to dismantle the disused automobile.

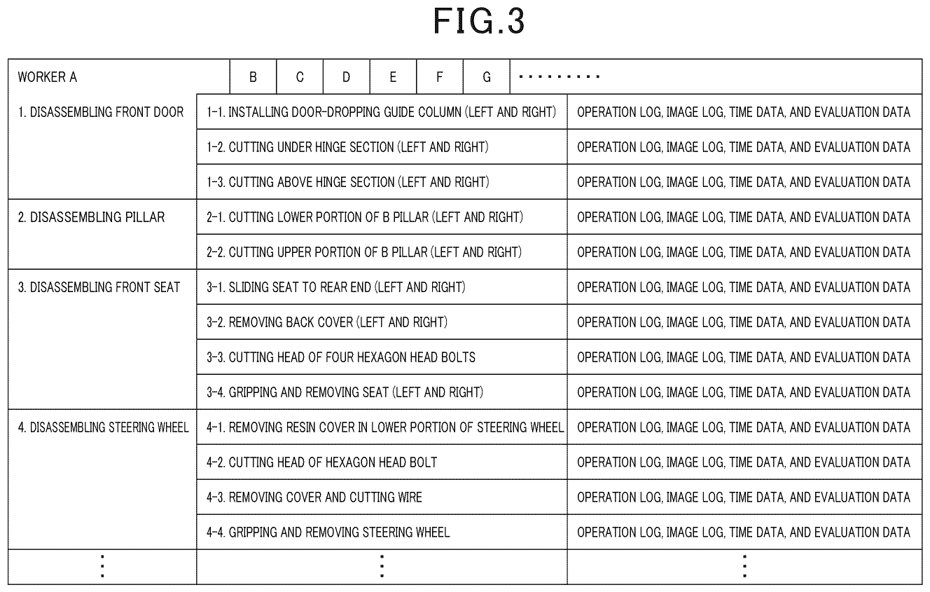

The disassembly of the disused automobile is successively performed in work element units prescribed in advance. As also shown in FIG. 3, described hereafter, steps of disassembling the disused automobile are divided into, for example, “1. Disassembling front door,” “2. Disassembling B pillar,” “3. Disassembling front seat,” and “4. Disassembling steering wheel.” In addition, the step of “1. Disassembling front door” is further divided into, for example, “1-1. Installing door-dropping guide column (left and right),” “1-2. Cutting under hinge section (left and right),” and “1-3. Cutting above hinge section (left and right).” The step of “2. Disassembling B pillar” is divided into, for example, “2-1. Cutting lower portion of B pillar (left and right),” and “2-2. Cutting upper portion of B pillar (left and right).” In a similar manner, the steps of “3. Disassembling front seat” and “4. Disassembling steering wheel” are also divided into a plurality of steps. In this case, a unit of work into which the work is ultimately divided is a work element unit. Here, the steps of disassembling the disused automobile also include steps other than those described above. These steps may be successively performed by a single worker or may be divided among a plurality of workers.

For example, the camera 9 may be set so as to be capable of moving on a rail that is laid around an overall periphery of the disused automobile. The camera 9 has an auto-focus function for automatically adjusting a focal point using a sensor, a motor, and the like, and a function for detecting a distance to and size of an image area. The camera 9 simultaneously captures images of a work section of the disused automobile and the attachment on the follower robot 8, and outputs the captured images including distance and size and time-series data indicating imaging positions as an image log. Here, the camera 9 may be a single camera or a plurality of cameras.

The control unit 4 includes a communication unit 4a, a storage unit 4b, and a calculation unit 4c. The communication unit 4a is an interface for transmitting and receiving electrical signals. The communication unit 4a transmits and receives electrical signals to and from the log collection system 3, the database 5, and the like. The storage unit 4b is a non-transient, tangible storage medium that non-temporarily stores therein data, programs, and the like that can be read by a computer or processor. The storage unit 4b has a volatile memory and a non-volatile memory, and can be a memory type, a disk type, a tape type, or the like. The storage unit 4b stores therein various types of data inputted to the communication unit 4a, various programs and various reference values used by the calculation unit 4c for calculation processes, various processing results from the calculation unit 4c, and the like.

The calculation unit 4c has a processor. The processor includes, among constituent elements of a computer, a processing unit that carries out calculation and conversion of data, execution of programs, control of other devices, and the like. The processor typically includes a central processing unit (CPU) that controls the overall computer or a micro processing unit (MPU; microprocessor) in which some of the functions of the CPU are integrated. The calculation unit 4c processes electrical signals inputted from the outside through the communication unit 4a based on a predetermined procedure, and outputs the electrical signals processed based on the predetermined procedure to the outside through the communication unit 4a.

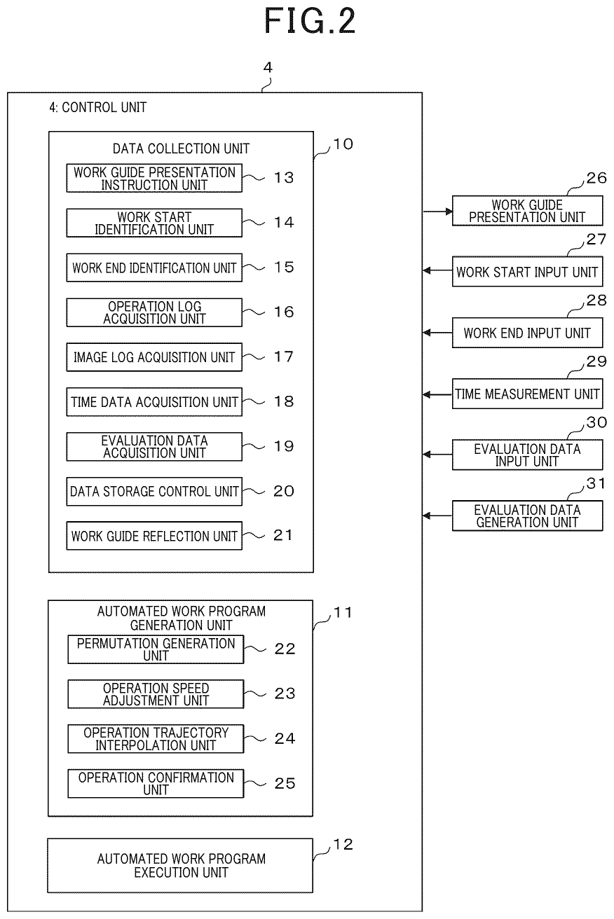

As shown in FIG. 2, the control unit 4 includes a data collection unit 10, an automated work program generation unit 11, and an automated work program execution unit 12 for each function. The data collection unit 10 collects data required to generate the automated work program by the calculation unit 4c performing a data collection process by a data collection program. The automated work program generation unit 11 generates the automated work program by the calculation unit 4c performing an automated work program generation process by an automated work program generation program. The automated work program execution unit 12 executes the automated work program by the calculation unit 4c performing an automated work program execution process by an automated work program execution program. The data collection program, the automated work program generation program, and the automated work program execution program are stored in the storage unit 4b. Here, the calculation unit that performs the data collection process, the calculation unit that performs the automated work program generation process, and the calculation unit that performs the automated work program execution process may be separate calculation units. In addition, the storage unit that stores therein the data collection program, the storage unit that stores therein the automated work program generation program, and the storage unit that stores therein the automated work program execution program may be separate storage units.

The data collection unit 10 includes a work guide presentation instruction unit 13, a work start identification unit 14, a work end identification unit 15, an operation log acquisition unit 16, an image log acquisition unit 17, a time data acquisition unit 18, an evaluation data acquisition unit 19, a data storage control unit 20, and a work guide reflection unit 21.

The work guide presentation instruction unit 13 outputs a work guide presentation instruction signal indicating a work process for work elements to a work guide presentation unit 26, and causes the work guide presentation unit 26 to present the work guide. For example, the work guide presentation unit 26 may be a monitor that displays the work guide. The worker operates the leader robot 6 while viewing the work guide presented in the work guide presentation unit 26 and manually performs the work of disassembling the disused automobile. According to the present embodiment, a configuration in which the work guide is displayed is given as an example. However, a configuration in which the work guide is audibly outputted or a configuration in which both the display and the audio output of the work guide are used is also possible.

The worker performs a start operation through a work start input unit 27 every time a work element is started. Upon receiving the start operation for the work element by the worker, the work start input unit 27 outputs a work start reception signal to the work start identification unit 14. The work start identification unit 14 identifies the start of the work element when the work start reception signal is inputted from the work start input unit 27. Here, the start of the work element may be identified based on the operation log or the image log, for example, in addition to the start operation by the worker.

The worker performs an end operation through a work end input unit 28 every time a work element is ended. Upon receiving the end operation for the work element by the worker, the work end input unit 28 outputs a work end reception signal to the work end identification unit 15. The work end identification unit 15 identifies the end of the work element when the work end reception signal is inputted from the work end input unit 28. Here, the end of the work element may be identified based on the operation log or the image log, for example, in addition to the end operation by the worker. In addition, when work elements are successively performed, the end of a preceding work element may be identified by the start of a subsequent work element being identified.

The operation log acquisition unit 16 acquires the operation log inputted from the follower robot 8 of the disassembly system 7. The image log acquisition unit 17 acquires the image log inputted from the camera 9 of the disassembly system 7.

A time measurement unit 29 outputs time data to the time data acquisition unit 18. The time data acquisition unit 18 acquires the time data indicating an amount of time required to perform the work element based on a difference between the time at which the start of the work element is identified by the work start identification unit 14 and the time at which the end of the work element is identified by the work end identification unit 15. That is, if a single worker repeatedly performs the same work element or if a plurality of workers perform the same work element, each execution of the work element may be rated good or poor based on the time data.

When an input operation for evaluation data by the worker is received, an evaluation data input unit 30 outputs an evaluation data reception signal indicating the evaluation data received through the input operation to the evaluation data acquisition unit 19. An evaluation data generation unit 31 generates the evaluation data by a predetermined evaluation algorithm prescribed in advance and outputs an evaluation data generation signal indicating the generated evaluation data to the evaluation data acquisition unit 19. The evaluation data acquisition unit 19 acquires the evaluation data when the evaluation data reception signal is inputted from the evaluation data input unit 30 or the evaluation data generation signal is inputted from the evaluation data generation unit 31. That is, if a single worker repeatedly performs the same work element or if a plurality of workers perform the same work element, each execution of the work element may be rated good or poor based on the evaluation data.

The evaluation data is an index that indicates an evaluation of an execution result of the work element. For example, the evaluation data is evaluation data based on a degree of load placed on the follower robot 8 when the follower robot 8 performs the work of disassembling the disused automobile, evaluation data based on a degree of damage to the disused automobile, or evaluation data based on a degree of damage to a recyclable component. For example, the evaluation data may be a numerical evaluation score. The recyclable component is, for example, a component such as a side mirror or a bumper attached to the disused automobile and is a component that can be reused if the degree of damage are relatively small.

For example, if the degree of load placed on the follower robot 8 is relatively small, the evaluation data is relatively high. If the degree of load placed on the follower robot 8 is relatively large, the evaluation data is relatively low. If the degree of damage to the disused automobile is relatively small, the evaluation data is relatively high. If the degree of damage to the disused automobile is relatively large, the evaluation data is relatively low. If the degree of damage to the recyclable component is relatively small, the evaluation data is relatively high. If the degree of damage to the recyclable component is relatively large, the evaluation data is relatively low. According to the present embodiment, a configuration in which both the evaluation data input unit 30 and the evaluation data generation unit 31 are used is given as an example. However, a configuration including only either of the evaluation data input unit 30 and the evaluation data generation unit 31 is also possible.

As shown in FIG. 3, the data storage control unit 20 stores the operation logs acquired by the operation log acquisition unit 16, the image logs acquired by the image log acquisition unit 17, the time data acquired by the time data acquisition unit, and the evaluation data acquired by the evaluation data acquisition unit 19 in the database 5 in association as work element logs in work element units. In this case, if a plurality of workers are involved, the data storage control unit 20 stores the work element logs in work element units for each worker.

The work guide reflection unit 21 reflects the work element logs in work element units stored in the database 5 in the work guide.

The automated work program generation unit 11 generates the automated work program by combining optimal work element logs, described hereafter. The automated work program generation unit 11 includes a permutation generation unit 22, an operation speed adjustment unit 23, an operation trajectory interpolation unit 24, and an operation confirmation unit 25. The permutation generation unit 22 selects the optimal work element logs in work element units in accordance to a predetermined rule based on the operation logs, the image logs, the time data, and the evaluation data, and generates a permutation of the selected optimal work element logs.

For example, if the rule is to select the work elements having the highest evaluation data, the permutation generation unit 22 selects the work elements having the highest evaluation data in work element units. For example, if the rule is to select the work elements having the shortest time data, the permutation generation unit 22 selects the work elements having the shortest time data in work element units.

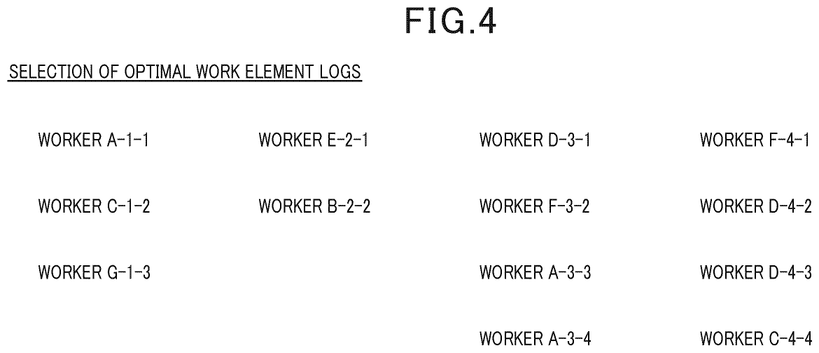

When selecting the work elements having the highest evaluation data in work element units, as shown in FIG. 4, if the evaluation data for worker A is the highest regarding the work element “1-1. Installing door-dropping guide column (left and right),” for example, the permutation generation unit 22 selects the work element log of worker A as the optimal work element log. If the evaluation data for worker C is the highest regarding the work element “1-2. Cutting under hinge section (left and right),” for example, the permutation generation unit 22 selects the work element log of worker C as the optimal work element log. The permutation generation unit 22 similarly selects the optimal work element logs for all work elements.

After selecting the optimal work element logs for all work elements, the permutation generation unit 22 generates a permutation of the selected optimal work element logs. As described above, the permutation generation unit 22 selects the work element log of worker A, for example, as the optimal work element log for the work element “1-1. Installing door-dropping guide column (left and right),” selects the work element log of worker C, for example, as the optimal work element log for the work element “1-2. Cutting under hinge section (left and right),” and selects the optimal work element logs for the subsequent work elements. Then, the permutation generation unit 22 generates a permutation of the selected optimal work element logs.

The operation speed adjustment unit 23 adjusts an operation speed of the follower robot 8 for the work elements in the permutation of the optimal work element logs generated by the permutation generation unit 22. For example, the operation speed adjustment unit 23 determines whether an operation log that does not involve contact between the attachment on the follower robot 8 and the disused automobile is present in operation logs in which the worker works at a low speed. When determined that an operation log that does not involve contact between the attachment on the follower robot 8 and the disused automobile is present, the operation speed adjustment unit 23 extracts the operation log and adjusts the operation speed so that the operation speed of the follower robot 8 is improved to a limit speed for the segment of the extracted operation log. That is, the operation speed adjustment unit 23 adjusts the operation speed to exceed the work speed of the worker during the segment of the operation log that does not involve contact between the attachment on the follower robot 8 and the disused automobile.

In addition, the operation speed adjustment unit 23 adjusts the operation speed of the follower robot 8 taking into consideration differences in speed before and after the work element. At the time of switching between work elements, a difference between the operation speed of the follower robot 8 at the end of the preceding work element and the operation speed of the follower robot 8 at the start of the subsequent work element is preferably small. When the difference in operation speed of the follower robot 8 at the time of switching between work elements is large, the operation of the follower robot 8 at the time of switching between work elements may no longer be seamless. The operation speed adjustment unit 23 calculates the difference in operation speed of the follower robot 8 between the preceding and subsequent work elements. If the calculated difference is equal to or greater than a predetermined value, the operation speed adjustment unit 23 adjusts the operation speed of the follower robot 8 for the work elements so that the difference in operation speed of the follower robot 8 between the preceding and subsequent work elements is less than the predetermined value.

That is, for example, the operation speed adjustment unit 23 calculates the difference between the operation speed of the follower robot 8 at the end of the preceding work element and the operation speed of the follower robot 8 at the start of the subsequent work element. For example, if the operation speed of the follower robot 8 at the end of the preceding work element is faster than the operation speed of the follower robot 8 at the start of the subsequent work element and the difference is equal to or greater than the predetermined value, the operation speed adjustment unit 23 adjusts the operation speed of the follower robot 8 at the end of the preceding work element to be slower or adjusts the operation speed of the follower robot 8 at the start of the subsequent work element to be faster, thereby suppressing the difference in operation speed of the follower robot 8 at the time of switching between the work elements. For example, if the operation speed of the follower robot 8 at the end of the preceding work element is slower than the operation speed of the follower robot 8 at the start of the subsequent work element and the difference is equal to or greater than the predetermined value, the operation speed adjustment unit 23 adjusts the operation speed of the follower robot 8 at the end of the preceding work element to be faster or adjusts the operation speed of the follower robot 8 at the start of the subsequent work element to be slower, thereby suppressing the difference in operation speed of the follower robot 8 at the time of switching between the work elements.

The operation trajectory interpolation unit 24 interpolates an operation trajectory of the follower robot 8 between work elements in the permutation of the optimal work element logs generated by the permutation generation unit 22. The operation trajectory indicates an operation trajectory corresponding to the position and attitude of the follower robot 8. At the time of switching between work elements, the operation trajectory of the follower robot 8 at the end of the preceding work element and the operation trajectory of the follower robot 8 at the start of the subsequent work element preferably coincide. If the operation trajectories of the follower robot 8 at the time of switching between work elements do not coincide, the operation of the follower robot 8 at the time of switching between work elements may no longer be seamless. The operation trajectory interpolation unit 24 calculates a difference in the operation trajectory before and after the work element and linearly interpolates the operation trajectory of the follower robot 8 based on the calculated difference.

That is, the operation trajectory interpolation unit 24 linearly interpolates the operation trajectory of the follower robot 8 so that three-dimensional coordinates of a specific point of the follower robot 8 at the end of the preceding work element and three-dimensional coordinates of a specific point of the follower robot 8 at the start of the subsequent work element are connected by a straight line. Here, in a case in which an obstruction is present on a linear path formed by linear interpolation, the operation trajectory interpolation unit 24 interpolates the operation trajectory of the follower robot 8 so as to avoid the obstruction.

The operation confirmation unit 25 confirms the operation of the automated work program by a simulator that reproduces the operation of the follower robot 8 in a virtual space.

The automated work program execution unit 12 executes the automated work program generated by the automated work program generation unit 11.

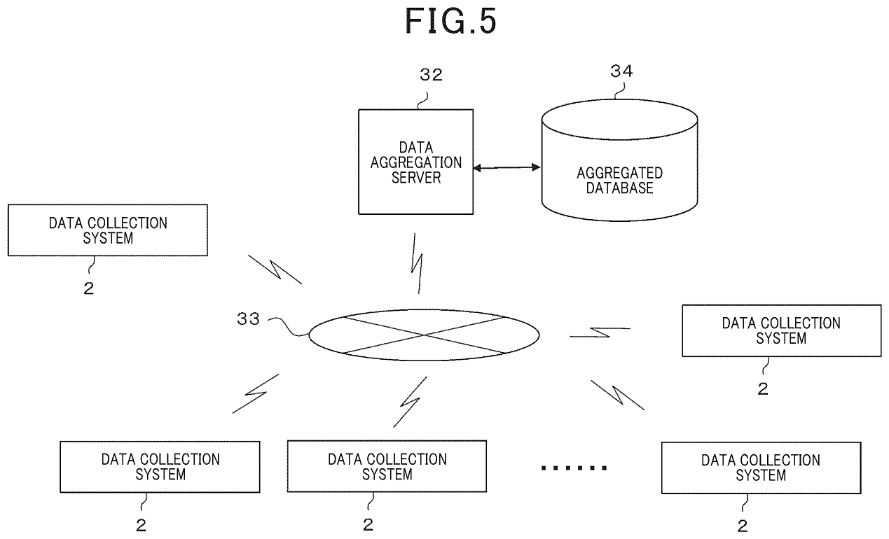

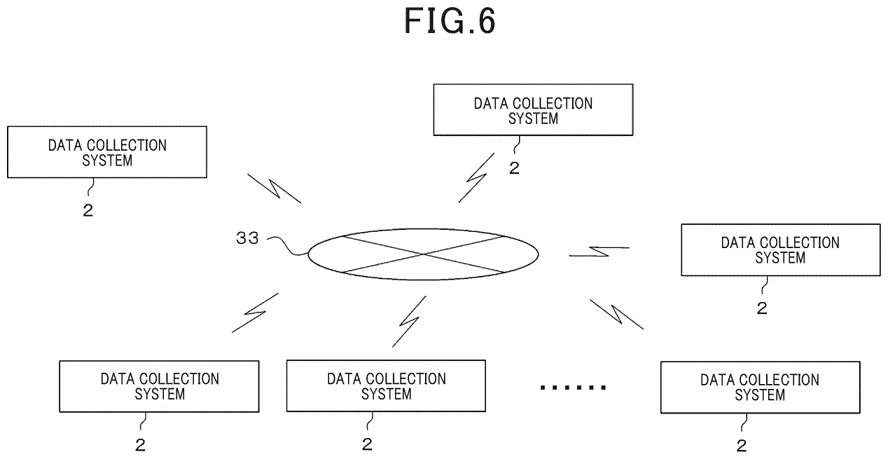

As shown in FIG. 5 and FIG. 6, the data collection system 2 configured as described above can be connected to another data collection system 2 by a communication network so as to be capable of data communication. As a mode in which a plurality of data collection systems 2 are connected, for example, there is a mode in which a data aggregation server that aggregates data of a plurality of data collection systems 2 is set and a mode in which a data aggregation server is not set.

As shown in FIG. 5, in the mode in which the data aggregation server is set, the plurality of data collection systems 2 and a data aggregation server 32 (corresponding to a data aggregation unit) are connected by a communication network 33 so as to be capable of data communication. The data aggregation server 32 is connected to an aggregation database 34. The work element logs in work element units stored in the database 5 of each data collection system 2 are transmitted to the data aggregation server 32 over the communication network 33 from each data collection system 2 at, for example, a timing at which recorded content of the database 5 is updated or a fixed periodic timing, and then aggregated in the aggregation database 34 and shared. That is, for example, in a case in which the data collection systems 2 are set in a plurality of bases in disassembly plants A, B, and C, the work element logs in work element units of a worker at the disassembly plant A, a worker at the disassembly plant B, and a worker at the disassembly plant C are aggregated in the aggregation database 34. If there is a plurality of workers at each of the disassembly plants A, B, and C, the respective work element logs in work element units of the plurality of workers at the disassembly plant A, the plurality of workers at the disassembly plant B, and the plurality of workers at the disassembly plant C are aggregated in the aggregation database 34.

The work element logs in work element units aggregated in the aggregation database 34 are delivered to the automated work system 1 over the communication network 33 from the data aggregation server 32 at, for example, the timing at which the recorded content of the aggregation database 34 is updated or a fixed periodic timing. That is, the work element logs in work element units from the plurality of bases are delivered to the automated work system 1. In the automated work system 1, when the automated work program generation unit 11 generates the automated work program as described above, the automated work program generation unit 11 may select the optimal work element logs from the work element logs stored in the own database 5, that is, local work element logs corresponding to one base, or select the optimal work element logs from the work element logs delivered from the data aggregation server 32, that is, global work element logs corresponding to the plurality of bases.

As shown in FIG. 6, in the mode in which the data aggregation server is not set, the plurality of data collection systems 2 are connected by the communication network 33 so as to be capable of data communication. In this case, the database 5 of each data collection system 2 provides the function of the aggregation database 34 of the data aggregation server 32 described above. The work element logs in work element units stored in the database 5 of each data collection system 2 are, for example, transmitted from the data collection system 2 to another data collection system 2 over the communication network 32 and shared at, for example, the timing at which the recorded content of the aggregation database 34 is updated or a fixed periodic timing. The work element logs in work element units stored in the database 5 of each data collection system 2 are used by the automated work system 1 or delivered to the automated work system 1 over the communication network 33 at, for example, the timing at which the recorded content of the aggregation database 34 is updated or a fixed periodic timing. In this case as well, when the automated work program is generated as described above, the automated work system 1 may select the optimal work element logs from the work element logs stored in the own database 5, that is, local work element logs corresponding to one base, or select the optimal work element logs from the work element logs delivered from another automated work system 1, that is, global work element logs corresponding to the plurality of bases.

In addition, the work element logs in work element units are not limited to data acquired using the disused automobile that is a real machine, as described above, and may be data acquired using a model or a simulator. In this case, the model is a scaled-down model of an automobile formed by three-dimensional molding or the like. In cases in which the data of the work element logs in work element units is collected using a model, the leader robot 6 and the follower robot 8 are smaller in size that those in cases in which a real machine is used. The simulator is a three-dimensional model of an automobile. In cases in which the data of the work element logs in work element units is collected using a simulator, the leader robot 6 is identical or smaller in size than that in cases in which a real machine is used and the follower robot 8 is a virtual robot that operates within the simulator. As a result of the work element logs in work element units being able to be acquired by a model or in a simulator, the work element logs in work element units can be collected from a larger number of workers even in an environment in which the disused automobile that is a real machine is not readily available. Here, the environments faced by the workers do not necessarily fully match in the cases using the real machine, the model, or the simulator. Therefore, for example, differences in environments may be complemented through setting of a coefficient or the like.

Furthermore, when the work element logs in work element units are collected, a game element may be included. The game element refers to creating competition over quality of evaluation data or time data and providing incentives such as prize money for winners based on the competition results. Through use of the game element, a person who does not actually dismantle the disused automobile can be included as a collection target for work element logs, and an expansion of collection targets for work element logs can be expected. Improved collection efficiency for work element logs can be expected as a result of creating competition over the quality of evaluation data or time data and providing incentives such as prize money for winners.

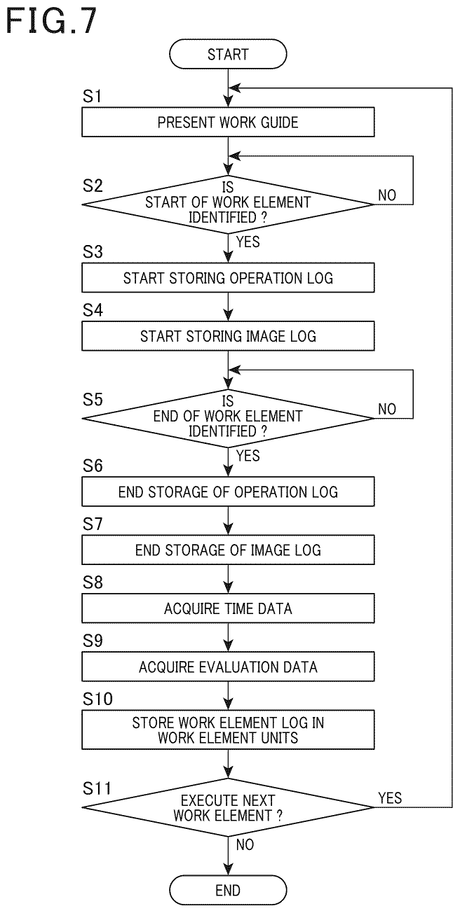

Next, workings of the above-described configuration will be described with reference to FIG. 7 to FIG. 9. The control unit 4 performs the data collection process, the automated work program generation process, and the automated work program execution process. The processes will be successively described below. Here, the data collection process and the automated work program generation process may use either of the local optimal work element logs corresponding to a single base or the global optimal work element logs corresponding to a plurality of bases, as described above.

### (1) Data Collection Process (See FIG. 7)

When the data collection process is started, the control unit 4 outputs the presentation instruction signal to the work guide presentation unit 26 and causes the work guide presentation unit 26 to present the work guide (S1; corresponding to a work guide presentation instructing step). The control unit 4 then waits for identification of the start of a work element (S2).

When the work start reception signal is inputted from the work start input unit 27 as a result of the work start input unit 27 receiving the start operation for the work element from the worker, the control unit 4 determines that the start of the work element is identified (YES at S2; corresponding to a work start identifying step). The control unit 4 starts storing the operation log inputted from the follower robot 8 of the disassembly system 7 (S3; corresponding to an operation log acquiring step) and starts storing the image log inputted from the camera 9 of the disassembly system 7 (S4; corresponding to an image log acquiring step). The control unit 4 then waits for identification of the end of the work element (S5).

When the work end reception signal is inputted from the work end input unit 28 as a result of the work end input unit 28 receiving the end operation for the work element from the worker, the control unit 4 determines that the end of the work element is identified (YES at S5; corresponding to a work end identifying step). The control unit 4 ends storage of the operation logs inputted from the follower robot 8 of the disassembly system 7 (S6) and ends storage of the image logs inputted from the camera 9 of the disassembly system 7 (S7).

The control unit 4 acquires the time data indicating the amount of time required to execute the work element based on the difference between the time at which the start of the work element is identified and the time at which the end of the work element is identified (S8; corresponding to a time data acquiring step). When the evaluation data reception signal is inputted from the evaluation data input unit 30 or when the evaluation data generation signal is inputted from the evaluation data generation unit 31, the control unit 4 acquires the evaluation data (S9; corresponding to an evaluation data acquiring step).

The control unit 4 stores the work element logs in work element units in the database 5 in association with the operation logs, the image logs, the time data, and the evaluation data (S10; corresponding to a data storage control step). The control unit 4 determines whether a next work element from which data is to be collected is to be executed (S11). When determined that the next work element from which data is to be collected is to be executed (YES at S11), the control unit 4 returns to step S1, described above, and repeats step S1 and subsequent steps. When determined that the next work element from which data is to be collected is not to be executed (NO at S11), the control unit 4 ends the data collection process.

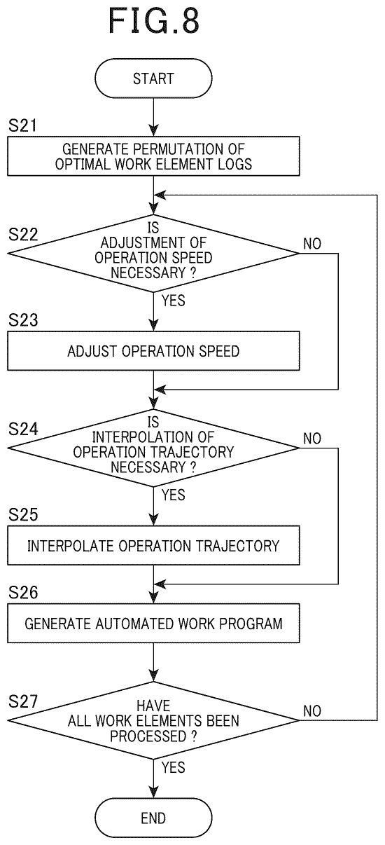

### (2) Automated Work Program Generation Process (See FIG. 8)

When the automated work program generation process is started, the control unit 4 selects the optimal work element logs in work element units based on a predetermined rule as described above, and generates a permutation of the selected optimal work element logs (S21). That is, the control unit 4 selects the work elements having the highest evaluation data, if the rule is to select the work elements having the highest evaluation data. The control unit 4 selects the work elements having the shortest time data for each work element if the rule is to select the work elements having the shortest time data. Here, for example, the control unit 4 may combine the rule to select the work elements having the highest evaluation data and the rule to select the work elements having the shortest time data. For example, the control unit 4 may apply the rule to select the work elements having the highest evaluation data from “1-1” to “2-2” and the rule to select the work element having the shortest time data from “3-1” to “4-4.”

The control unit 4 determines whether adjustment of the operation speed of the follower robot 8 for the work elements is necessary (S22). When determined that adjustment of the operation speed of the follower robot 8 is necessary (YES at S22), the control unit 4 adjusts the operation speed of the follower robot 8 for the work elements (S23). When determined that the adjustment of the operation speed of the follower robot 8 is not necessary (NO at S22), the control unit 4 does not adjust the operation speed of the follower robot 8 for the work elements.

The control unit 4 determines whether interpolation of the operation trajectory of the follower robot 8 between work elements is necessary (S24). When determined that interpolation of the operation trajectory of the follower robot 8 is necessary (YES at S24), the control unit 4 interpolates the operation trajectory of the follower robot 8 between work elements (S25). When determined that interpolation of the operation trajectory of the follower robot 8 is not necessary (NO at S24), the control unit 4 does not interpolate the operation trajectory.

The control unit 4 generates the automated work program for the corresponding work element based on the operation logs and the image logs of the corresponding work element (S26; corresponding to an automated work program generating step). The control unit 4 determines whether the automated work program is generated for all work elements (S27). When determined that the automated work program is not generated for all work elements, that is, there is a work element for which the automated work program is not yet generated (NO at S27), the control unit 4 returns to step S22 and repeats step S22 and subsequent steps.

When determined that the automated work program is generated for all work elements, that is, there is no work element for which the automated work program has not yet been generated (YES at S27), the control unit 4 ends the automated work program generation process.

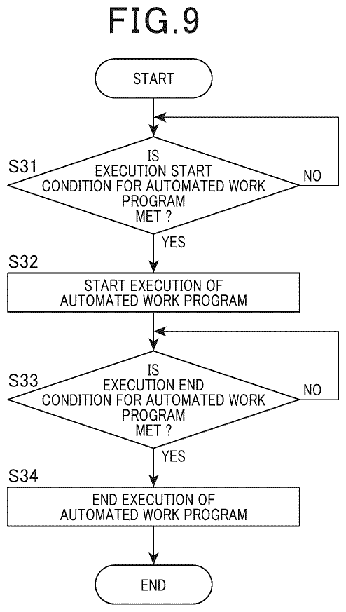

### (3) Automated Work Program Execution Process (See FIG. 9)

When the automated work program execution process is started, when determined that an execution start condition for the automated work program is met (YES at S31), the control unit 4 starts execution of the automated work program (S32). When determined that an end condition for execution of the automated work program is met (YES at S33), the control unit 4 ends the execution of the automated work program (S34) and ends the automated work program execution process.

As described above, according to the first embodiment, the following working effects can be achieved. In the data collection system 2, a worker can issue an instruction for presentation of a work guide and thereby divide a work operation into work element units based on the work guide and collect data. The work element logs of work element units to which the operation logs, the image logs, the time data, and the evaluation data are associated based on execution of the work elements are stored in the database 5. With reference to the time data or the evaluation data, the work element logs having excellent time data or evaluation data can be selected as the optimal work element logs in work element units. As a result of the optimal work element logs selected in work element units being combined, the automated work program can be generated. As a result, machine learning of an enormous amount of learning data in work element units is not required. The data required to generate the automated work program can be appropriately and efficiently collected.

Evaluation data inputted by the worker or evaluation data calculated based on a predetermined evaluation algorithm prescribed in advance is acquired. The optimal work element log can be selected with reference to the evaluation data inputted by the worker or the evaluation data calculated from a predetermined evaluation algorithm prescribed in advance.

Evaluation data based on a degree of load placed on the follower robot 8 is acquired. As a result of the evaluation data being ranked based on the degree of load placed on the follower robot 8, an automated work program specially generated to suppress load placed on the follower robot 8 can be generated. Promotion of work that suppresses load placed on the follower robot 8 can be expected.

Evaluation data based on a degree of damage to the disused automobile is acquired. As a result of the evaluation data being ranked based on the degree of damage to the disused automobile, an automated work program specially generated to suppress damage to the disused automobile can be generated. Promotion of work that suppresses damage to the disused automobile can be expected.

Evaluation data based on a degree of damage to a recyclable component attached to the disused automobile is acquired. As a result of the evaluation data being ranked based on the degree of damage to the recyclable component, an automated work program specially generated to suppress damage to the recyclable component can be generated. Promotion of work that suppresses damage to the recyclable component can be expected.

The work element logs in work element units are reflected in the work guide. The work guide reflecting the work element logs in work element units can be presented in the work guide presentation unit 26.

The work element logs in work element units are acquired using a real machine, a model, or a simulator. The work element logs in work element units can be collected from a larger number of workers. The work element logs in work element units can be collected even in an environment in which a real machine is not readily available, as a result of a model or a simulator being used.

The work element logs in work element units including a game element are acquired. As a result of the game element being used, a person who does not actually dismantle the disused automobile can be included as a collection target for the work element logs. Expansion of the collection targets for the work element logs can be expected.

The work element logs in work element units of a plurality of data collection systems 2 can be shared. The collection targets for the work element logs in work element units can be expanded, and collection of work element logs in work element units having excellent evaluation data and time data can be expected.

The optimal work element logs in work element units are selected under a predetermined rule based on the operation logs, image logs, time data, and evaluation data. A permutation of the selected optimal work element logs is generated, and the automated work program is generated. For example, if the rule is to select the work elements having the highest evaluation data, as a result of the work elements having the highest evaluation data being selected in work element units, an automated work program reflecting the work elements having the highest evaluation data can be generated. For example, if the rule is to select the work elements having the shortest time data, as a result of the work elements having the shortest time data being selected in work element units, an automated work program reflecting the work elements having the shortest time data can be generated.

The operation speed of the follower robot 8 for the work elements in the permutation of the optimal work element logs is adjusted. For example, the operation speed of the follower robot 8 can be improved to a limit speed during a segment of an operation log that does not involve contact between the attachment on the follower robot 8 and the disused automobile in the operation logs in which the worker works at a low speed. In addition, as a result of the difference between the operation speed of the follower robot 8 at the end of the preceding work element and the operation speed of the follower robot 8 at the start of the subsequent work element at the time of switching between work elements being reduced, the operation of the follower robot 8 can be made seamless at the time of switching between work elements.

The operation trajectory of the follower robot 8 between work elements in the permutation of the optimal work element logs is interpolated. Even if the operation trajectory of the follower robot 8 at the end of the preceding work element and the operation trajectory of the follower robot 8 at the start of the subsequent work element do not coincide at the time of switching between work elements, as a result of the operation trajectory of the follower robot 8 being linearly interpolated, the operation of the follower robot 8 can be made seamless when switching between work elements.

The operation of the automated work program is confirmed by a simulator that reproduces the operation of the follower robot 8 in virtual space. The operation of the automated work program can be tested in virtual space.

### Second Embodiment

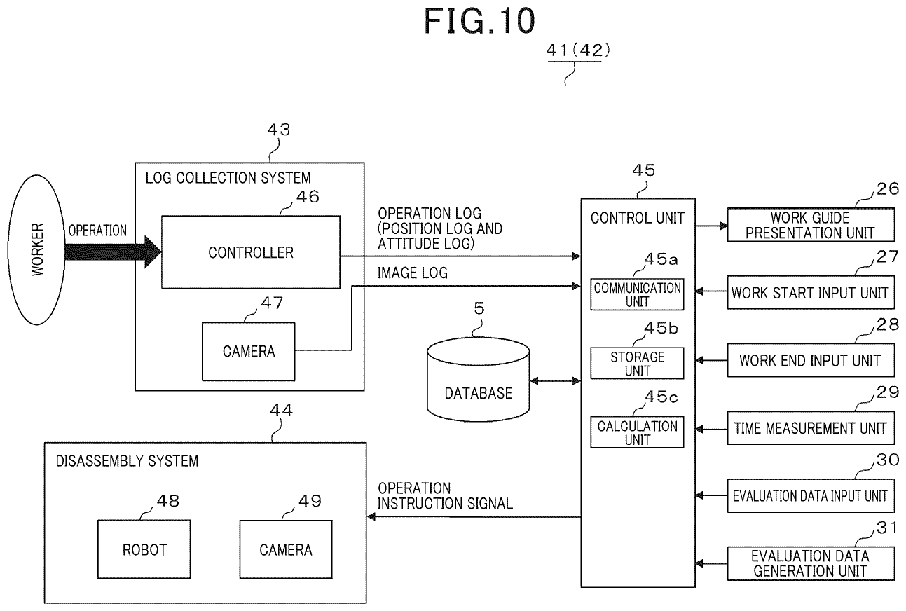

A second embodiment will be described with reference to FIG. 10. The first embodiment is configured such that, for example, the worker operates the leader robot 6, and the follower robot 8 operates so as to follow the leader robot 6 and outputs operation logs. However, the second embodiment is configured such that, for example, the worker operates a controller and the controller outputs the operation logs. According to the second embodiment, a robot performs the work of disassembling components removed from a disused automobile.

In a manner similar to the first embodiment, an example is given of a case in which data required to generate an automated work program is collected using a robot that performs the work of disassembling a component that is an actual real machine. In this case as well, the data collection system and the automated work system have an identical relationship.

As shown in FIG. 10, an automated work system 41 has an identical relationship with a data collection system 42. The automated work system 41 includes a log collection system 43 that collects logs accompanying the disassembly of a component removed from a disused automobile, a disassembly system 44, a control unit 45 that controls the overall system, and a database 5.

The log collection system 43 includes a controller 46 and a camera 47. For example, the controller 46 may be equipment that includes a control stick that can be operated by a worker. The controller 46 outputs time-series data prescribing an operation of the robot 48 based on an operation by the worker as an operation log. The camera 47 may be, for example, movably set in a robot for fixing a camera. The camera 47 provides a function for detecting distance and size of an imaging location. The camera 47 simultaneously captures images of a work section of a component removed from the disused automobile and an attachment on the controller 46, and outputs the captured images including distance and size and time-series data indicating imaging positions as an image log. Here, the camera 47 may be a single camera or a plurality of cameras.

The disassembly system 44 includes a robot 48 (corresponding to a control target) that performs the work of disassembling the component removed from the disused automobile and a camera 49. The camera 49 provides a function for detecting distance and size of an imaging location. The camera 49 simultaneously captures images of the work section of the component removed from the disused automobile and an attachment on the controller 46. The robot 48 is similar to the follower robot 8 described according to the first embodiment. When an operation instruction signal is input from the control unit 45 through execution of an automated work program, the robot 48 operates based on the inputted operation instruction signal and automatically performs the work of disassembling the component removed from the disused automobile without requiring operation by the worker.

The control unit 45 is similar to the control unit 4 according to the first embodiment. That is, the control unit 45 includes a communication unit 45a, a storage unit 45b, and a calculation unit 45c. The units 45a to 45c respectively provide functions equivalent to those of units 4a to 4c. In addition, the control unit 45 includes the data collection unit 10, the automated work program generation unit 11, and the automated work program execution unit 12 for each function, and performs the data collection process, the automated work program generation process, and the automated work program execution process.

Here, the first embodiment is configured such that the disassembly system 7 is controlled as part of the log collection system 3. Because the follower robot 8 of the disassembly system 7 outputs the operation logs, the control unit 4 adjusts the operation speed and interpolates the operation trajectory of the follower robot 8 based on the operation logs outputted from the follower robot 8. Meanwhile, according to the second embodiment, the log collection system 43 and the disassembly system 44 are separately controlled, and the controller 46 of the log collection system 43 outputs the operation logs. Therefore, the control unit 45 adjusts the operation speed and interpolates the operation trajectory of the robot 48 of the disassembly system 44 based on the operation logs outputted from the controller 46.

As described above, according to the second embodiment, the following working effects can be achieved. In the automated work system 41, the work element logs of work element units to which the operation logs prescribing the operation of the robot 48, the image logs indicating images of the controller 46, the time data, and the evaluation data are associated are stored in the database 5. In a manner similar to the first embodiment, with reference to the time data or the evaluation data, the work element logs having excellent time data or evaluation data can be selected as the optimal work element logs in work element units. As a result of the optimal work element logs selected in work element units being combined, the automated work program can be generated.

The present disclosure includes the following aspects in addition to the citations in the scope of claims.

### [First Aspect]

A data collection system (2, 42) that collects data required to generate an automated work program that causes a control target to automatically perform predetermined work, the data collection system including: a work guide presentation instruction unit (13) that instructs presentation of a work guide that indicates a work process for work elements; an operation log acquisition unit (16) that acquires an operation log of a log collection system during execution of the work element; an image log acquisition unit (17) that acquires an image log of the log collection system during execution of the work element; a time data acquisition unit (18) that acquires time data indicating time required to execute the work element; an evaluation data acquisition unit (19) that acquires evaluation data indicating evaluation of an execution result of the work element; and a data storage control unit (20) that causes a data storage unit (5) to store therein a work element log in work element units in association with the operation log, the image log, the time data, and the evaluation data.

### [Second Aspect]

The data collection system according to the first aspect, in which the evaluation data acquisition unit acquires evaluation data inputted by a worker or evaluation data calculated by a predetermined evaluation algorithm prescribed in advance.

### [Third Aspect]

The data collection system according to the first or second aspect, in which the evaluation data acquisition unit acquires evaluation data that is based on a degree of load placed on the control target when the control target performs the predetermined work.

### [Fourth Aspect]

The data collection system according to any one of the first to third aspects, in which the control target performs work involving a work target as the predetermined work, and the evaluation data acquisition unit acquires evaluation data based on a degree of damage to the work target when the control target performs the predetermined work.

### [Fifth Aspect]

The data collection system according to any one of the first to fourth aspects, in which the work target of the control target performs work involving a work target including a recyclable component as the predetermined work; and the evaluation data acquisition unit acquires evaluation data based on a degree of damage to the recyclable component when the control target performs the predetermined work.

### [Sixth Aspect]

The data collection system according to any one of the first to fifth aspects including a work guide reflection unit (20) that reflects the work element logs in work element units stored in the data storage unit in the work guide.

### [Seventh Aspect]

The data collection system according to any one of the first to sixth aspects, in which the work element log in work element units is data acquired using a real machine, a model, or a simulator.

### [Eighth Aspect]

The data collection system according to any one of the first to seventh aspects, in which the work element log in work element units is data acquired so as to include a game element.

### [Ninth Aspect]

The data collection system according to the first aspect, in which the work element logs in work element units stored in a plurality of data storage units are shared.

### [Tenth Aspect]

The data collection system according to the ninth aspect, in which the work element logs in work element units stored in the data storage unit are transmitted to a data aggregation unit (32).

### OTHER EMBODIMENTS

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

The control unit and a method thereof described in the present disclosure may be actualized by a dedicated computer that is provided so as to be configured by a processor and a memory, the processor being programmed to provide one or a plurality of functions that are realized by a computer program. Alternatively, the control unit and a method thereof described in the present disclosure may be actualized by a dedicated computer that is provided by a processor being configured by a single dedicated hardware logic circuit or more. Further alternatively, the control unit and a method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible, computer-readable storage medium that can be read by a computer as instructions performed by the computer.

What is claimed is:

1. A data collection system that collects data required to generate an automated work program that causes a control target to automatically perform predetermined work, the data collection system comprising:
a work guide presentation instruction unit that instructs presentation of a work guide that indicates a work process for work elements;
an operation log acquisition unit that acquires an operation log of a log collection system during execution of the work element;
an image log acquisition unit that acquires an image log of the log collection system during execution of the work element;
a time data acquisition unit that acquires time data indicating time required to execute the work element;
an evaluation data acquisition unit that acquires evaluation data indicating evaluation of an execution result of the work element; and
a data storage control unit that causes a data storage unit to store therein a work element log in work element units in association with the operation log, the image log, the time data, and the evaluation data.

2. The data collection system according to claim 1, wherein:
the evaluation data acquisition unit acquires evaluation data inputted by a worker or evaluation data calculated by a predetermined evaluation algorithm prescribed in advance.

3. The data collection system according to claim 1, wherein:
the evaluation data acquisition unit acquires evaluation data that is based on a degree of load placed on the control target when the control target performs the predetermined work.

4. The data collection system according to claim 1, wherein:
the control target performs work involving a work target as the predetermined work; and
the evaluation data acquisition unit acquires evaluation data based on a degree of damage to the work target when the control target performs the predetermined work.

5. The data collection system according to claim 1, wherein:
the work target of the control target performs work involving a work target including a recyclable component as the predetermined work; and
the evaluation data acquisition unit acquires evaluation data based on a degree of damage to the recyclable component when the control target performs the predetermined work.

6. The data collection system according to claim 1, further comprising:
a work guide reflection unit that reflects the work element logs in work element units stored in the data storage unit in the work guide.

7. The data collection system according to claim 1, wherein:
the work element log in work element units is data acquired using a real machine, a model, or a simulator.

8. The data collection system according to claim 7, wherein:
the work element log in work element units is data acquired so as to include a game element.

9. The data collection system according to claim 1, wherein:
the work element logs in work element units stored in a plurality of data storage units are shared.

10. The data collection system according to claim 9, wherein:
the work element logs in work element units stored in the data storage unit are transmitted to a data aggregation unit.

11. An automated work system that collects data required to generate an automated work program that causes a control target to automatically perform predetermined work and generates the automated work program, the automated work system comprising:
a work guide presentation instruction unit that instructs presentation of a work guide that indicates a work process for work elements;
an operation log acquisition unit that acquires an operation log of a log collection system during execution of the work element;
an image log acquisition unit that acquires an image log of the log collection system during execution of the work element;
a time data acquisition unit that acquires time data indicating time required to execute the work element;
an evaluation data acquisition unit that acquires evaluation data indicating evaluation of an execution result of the work element;
a data storage control unit that causes a data storage unit to store therein a work element log in work element units in association with the operation log, the image log, the time data, and the evaluation data; and
an automated work program generation unit that generates the automated work program based on the work element logs in work element units stored in the data storage unit.

12. The automated work system according to claim 11, wherein:
the automated work program generation unit includes
a permutation generation unit that selects optimal work element logs in work element units under a predetermined rule based on the operation logs, the image logs, the time data, and the evaluation data, and generates a permutation of the selected optimal work element logs.

13. The automated work system according to claim 12, further comprising:
a control target that automatically performs the predetermined work.

14. The automated work system according to claim 13, wherein:
the automated work program generation unit includes
an operation speed adjustment unit that adjusts an operation speed of the control target for the work elements in the permutation of the optimal work element logs generated by the permutation generation unit.

15. The automated work system according to claim 13, wherein:
the automated work program generation unit includes
an operation trajectory interpolation unit that interpolates an operation trajectory of the control target between work elements in the permutation of the optimal work element logs generated by the permutation generation unit.

16. The automated work system according to claim 11, wherein:
the automated work program generation unit includes
an operation confirmation unit that confirms operation of the automated work program by a simulator that reproduces the operation of the control target in virtual space.

17. A non-transitory computer-readable storage medium storing therein a data collection program that is read and executed by a processor included in a control unit of a data collection system that collects data required to generate an automated work program that causes a control target to automatically perform predetermined work, the data collection program causing the processor to implement:
a work guide presentation instruction step of instructing presentation of a work guide that indicates a work process for work elements;
an operation log acquisition step of acquiring an operation log of a log collection system during execution of the work element;
an image log acquisition step of acquiring an image log of the log collection system during execution of the work element;
a time data acquisition step of acquiring time data indicating time required to execute the work element;
an evaluation data acquisition step of acquiring evaluation data indicating evaluation of an execution result of the work element; and
a data storage control step of causing a data storage unit to store therein a work element log in work element units in association with the operation log, the image log, the time data, and the evaluation data.

18. A non-transitory computer-readable storage medium storing therein an automated work program generation program that is read and executed by a processor included in a control unit of an automated work system that includes a data collection system that collects data required to generate an automated work program that causes a control target to automatically perform predetermined work and a control target that automatically performs the predetermined work, the automated work program generation program causing the processor to implement:
a work guide presentation instruction step of instructing presentation of a work guide that indicates a work process for work elements;
an operation log acquisition step of acquiring an operation log of a log collection system during execution of the work element;
an image log acquisition step of acquiring an image log of the log collection system during execution of the work element;
a time data acquisition step of acquiring time data indicating time required to execute the work element;
an evaluation data acquisition step of acquiring evaluation data indicating evaluation of an execution result of the work element;
a data storage control step of causing a data storage unit to store therein a work element log in work element units in association with the operation log, the image log, the time data, and the evaluation data; and
an automated work program generation step of generating the automated work program based on the work element logs in work element units stored in the data storage unit.
